(19) United States
(12) Patent Application Publication
(10) Pub. No.: US 2016/0157007 A1
(43) Pub. Date: Jun. 2, 2016

(54) FOUR-POLE EARPHONE DEVICE AND CONTROL METHOD THEREOF

(71) Applicant: WISOL CO., LTD., Osan-si (KR)

(72) Inventor: Ahn Kook LEE, Suwon-si (KR)

(21) Appl. No.: 14/734,366

(22) Filed: Jun. 9, 2015

(30) Foreign Application Priority Data
Dec. 1, 2014 (KR) 10-2014-0169725

(51) Int. Cl. H04R 1/10

(52) U.S. Cl. CPC H04R 1/1041

(57) ABSTRACT

Four-pole earphone device including left and right speaker terminals, microphone terminal and ground terminal includes first switch between the left and right speaker terminals to switch connection of the left and right speaker terminals; second switch between the right speaker terminal and control unit to switch connection of the right speaker terminal and the control unit; third switch between the right speaker terminal and microphone/key function unit to switch connection of the right speaker terminal and the microphone/key function unit; the control unit monitoring power from terminal equipment, controlling switching, of the first, second and third switches according to value of the power, and controlling the left and right speaker terminals, the microphone/key function unit and earphone output unit; and the microphone/key function unit connected to the microphone terminal and the control unit to perform microphone and key functions of the four-pole earphone device.

### BACKGROUND OF THE INVENTION

1. Field of the Invention

The present invention relates to a four-pole earphone device and a control method thereof, and more specifically, to a four-pole earphone device and a control method thereof, in which the four-pole earphone device having a left side speaker terminal, a right side speaker terminal and a microphone terminal and a ground terminal may perform five-pole terminal functions of a left side speaker function, a right side speaker function, a power supply function, a ground function and a microphone/key function through a switch control, and the four-pole earphone device is connected to a terminal equipment.

2. Background of the Related Art

An earphone device allows a user to listen to music or broadcast regardless of time and space without hindering other people when the user listens to audio using a terminal equipment. Generally, an earphone system for operating an earphone device is a system which allows a terminal equipment to sense connection of an earphone according to state change of the head of the earphone device electrically connected to the earphone connection interface of the terminal equipment.

Since a user increases volume when background noises are severe, such an earphone device may act as a factor generating hearing impairment when the user listens to music or broadcast for an extended period of time. Active noise cancelling techniques (ANC) are introduced recently to improve quality of sound of the earphone device. The active noise cancelling technique (ANC) is a technique of analyzing frequencies, magnitudes, sound qualities and the like of various kinds of sounds flowing into the earphone device and offsetting noises by sending out sound waves of reverse wavelength through a speaker. Such an active noise cancelling technique (ANC) is stated in the ‘Active Noise Cancelling System’ disclosed in Korean Patent Publication No. 10-2011-0097622.

However, there is a problem in that in order to apply such an active noise cancelling (ANC) technique to an earphone device, the interface of the earphone device should use a five-pole terminal further including a power supply terminal, in addition to a left side speaker terminal, a right side speaker terminal, a microphone terminal and a ground terminal.

### SUMMARY OF THE INVENTION

An object of the present invention is to have an earphone device receive power from a terminal equipment without including one more electrode.

In addition, another object of the present invention is to receive an audio signal while receiving power from a terminal equipment, by implementing a simple circuit.

To accomplish the above objects, according to one aspect of the present invention, there is provided a four-pole earphone device including a left side speaker terminal, a right side speaker terminal, a microphone terminal and a ground terminal, the device including: a first switch arranged between the left side speaker terminal and the right side speaker terminal to switch connection of the left side speaker terminal and the right side speaker terminal; a second switch arranged between the right side speaker terminal and a control unit to switch connection of the right side speaker terminal and the control unit; a third switch arranged between the right side speaker terminal and a microphone/key function unit to switch connection of the right side speaker terminal and the microphone/key function unit; the control unit for monitoring power received from a terminal equipment, controlling switching of the first switch, the second switch and the third switch according to a value of the received power, and controlling the left side speaker terminal, the right side speaker terminal, the microphone/key function unit and an earphone output unit; and the microphone/key function unit connected to the microphone terminal and the control unit to perform a microphone function and a key function of the four-pole earphone device.

When the four-pole earphone device is supplied with power from the terminal equipment, the microphone terminal may be supplied with the power from the terminal equipment.

When magnitude of the monitored power is smaller than a set value, the control unit may allow the left side speaker terminal to receive the audio signal transmitted from the terminal equipment, block the right side speaker terminal not to receive the audio signal transmitted from the terminal equipment by turning on the first switch and turning off the second switch, and connect the microphone/key function unit and the right side speaker terminal by turning on the third switch.

If the microphone/key function unit receives a key input signal, the control unit may transmit a frequency corresponding to the key input signal to the microphone terminal.

The frequency may be a single tone frequency.

According to another aspect of the present invention, there is provided a method of controlling a four-pole earphone device including a left side speaker terminal, a right side speaker terminal, a microphone terminal and a ground terminal, the method including the steps of an audio signal receiving step of receiving an audio signal from a terminal equipment, by the left side speaker terminal and the right side speaker terminal; a voltage monitoring step of monitoring voltage supplied from the microphone terminal, by a control module including a control unit which controls the left side speaker terminal, the right side speaker terminal and the microphone terminal; and a switching step of switching switch elements arranged in the control module according to a result of the monitoring at the voltage monitoring step, by the control unit.

The switching step may include: a second switch switching step of cutting off connection of the right side speaker terminal and the control unit by turning off the second switch arranged between the right side speaker terminal and the control unit, by the control unit; a first switch switching step of connecting the left side speaker terminal and the right side speaker terminal by turning on the first switch arranged between the left side speaker terminal and the right side speaker terminal, by the control unit; and a third switch switching step of connecting the right side speaker terminal and the microphone/key function unit by turning on the third switch arranged between the right side speaker terminal and the microphone/key function unit arranged at one side of the control module to perform a microphone or key function of the four-pole earphone device, by the control unit, which are performed when a value of the voltage monitored at the voltage monitoring step is smaller than a set value.

The control method may further include a frequency transmission step of transmitting, when a key input signal is input through the microphone/key function unit performing a microphone or key function of the four-pole earphone device, a frequency corresponding to the key input signal to the microphone terminal, by the control unit.

The frequency may be a single tone frequency.

According to another aspect of the present invention, there is provided a terminal equipment supporting a four-pole earphone device, the terminal equipment including: a left side audio terminal for transmitting an audio signal to a left side speaker terminal of the four-pole earphone device; a right side audio terminal for transmitting an audio signal to a right side speaker terminal of the four-pole earphone device; a microphone reception terminal for receiving an audio signal or a key connection signal from a microphone terminal of the four-pole earphone device; a common ground terminal which becomes a common ground terminal when it contacts with a ground terminal of the four-pole earphone device; a terminal control unit for controlling the left side audio terminal, the right side audio terminal, the microphone reception terminal, the common ground terminal and a power supply unit; and the power supply unit for supplying power to the four-pole earphone device through the microphone reception terminal.

The terminal equipment supporting a four-pole earphone device may further include: a left side audio processing unit connected to the left side audio terminal to process a left side audio signal; a right side audio processing unit connected to the right side audio terminal to process a right side audio signal; and a microphone/key processing unit connected to the microphone reception terminal to process a microphone signal and a key connection signal, in which the right side audio processing unit and the microphone/key processing unit are connected to a first terminal switch, and the right side audio terminal is connected to either the right side audio processing unit or the microphone/key processing unit according to switching of the first terminal switch.

### BRIEF DESCRIPTION OF THE DRAWINGS

FIG. 1 is a circuit diagram schematically showing a four-pole earphone device according to an embodiment of the present invention.

FIG. 2 is a circuit diagram schematically showing a control module according to an embodiment of the present invention.

FIG. 3 is a graph showing voltage monitored by a control unit according to an embodiment of the present invention.

FIG. 4 is an exemplary view schematically showing a frequency transmission step according to an embodiment of the present invention.

FIG. 5 is a table schematically showing a communication mode according to an embodiment of the present invention.

FIG. 6 is a flowchart schematically showing a method of controlling a four-pole earphone device according to an embodiment of the present invention.

FIG. 7 is a flowchart schematically showing a method of controlling switching of a four-pole earphone device according to an embodiment of the present invention.

FIG. 8 is a block diagram schematically showing a terminal equipment supporting a four-pole earphone device according to an embodiment of the invention.

### DETAILED DESCRIPTION OF THE PREFERRED EMBODIMENT

Details of the objects and technical configuration of the present invention described above and operational effects according thereto will be clearly understood hereinafter by the detailed description with reference to the accompanying drawings attached in the specification of the present invention.

The constitutional components expressed in this specification are merely examples for implementing the present invention. Accordingly, other components may be used in other implementations of the present invention without departing from the spirit and scope of the present invention. In addition, although each component can be implemented only in a pure hardware or software configuration, it also can be implemented by combining various hardware or software configurations performing the same function.

Expressions such as <voltage supply command>, <voltage supply circuit> and <supply voltage> of this specification may also be applied to all electrical signals which can be used in an earphone and may be applied and implemented like <electrical signal transmission command>, <electrical signal supply circuit> and <transmit an electrical signal>.

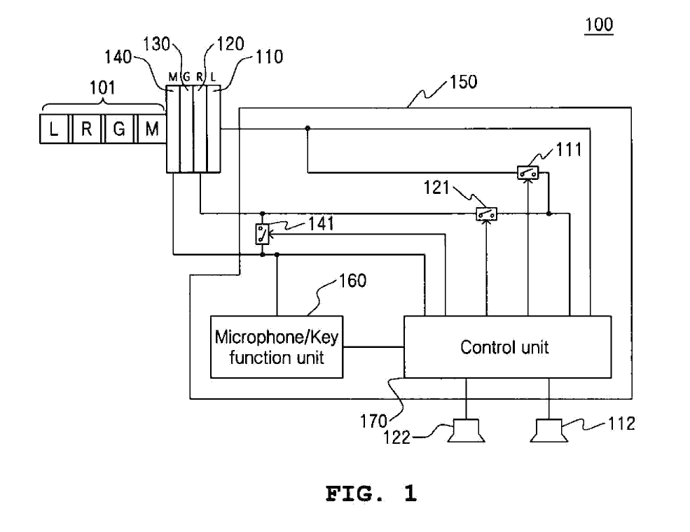

FIG. 1 is a circuit diagram schematically showing a four-pole earphone device according to an embodiment of the present invention. As shown in FIG. 1, a four-pole earphone device according to an embodiment of the present invention includes an earphone head 101 having a left side speaker terminal L, a right side speaker terminal R, a microphone terminal M and a ground terminal G, earphone output units 112 and 122 connected to the four-pole earphone head 101 to output audio signals, and a control module 150 connected to the four-pole earphone head 101 and the earphone output units 112 and 122 to control the earphone device 100, and the control module 150 controls connection to the four-pole earphone head 101 by arranging switch elements 111, 121 and 141. At one side of the earphone head 101, electrodes corresponding to the terminals L, R, M and G of the earphone head 101 are arranged and connected to the control module 150. The left side speaker terminal L is connected to a left side speaker electrode 110, the right side speaker terminal R is connected to a right side speaker electrode 120, the microphone terminal M is connected to a microphone electrode 140, and the ground terminal G is connected to a ground electrode 130.

The earphone device is a device for receiving an audio signal from a terminal equipment and outputting the received audio signal. Such an earphone device should be further provided with a power supply terminal, in addition to the four-pole terminals L, R, M and G, in order to simultaneously receive the audio signal and power from the terminal equipment. The four-pole earphone device 100 of the present invention is a device for simultaneously receiving an audio signal and power by using only the four-pole terminals L, R, M and G without further including the power supply terminal. To this end, the earphone device 100 according to an embodiment of the present invention controls connections between the terminals L, R, M and G and a control unit 170 of the control module 150 by arranging the switch elements 111, 121 and 141 in the control module 150.

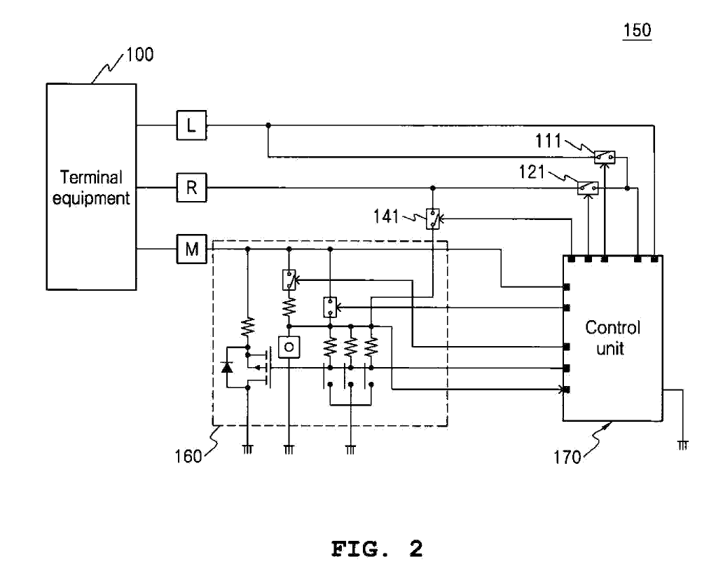

FIG. 2 is a circuit diagram schematically showing a control module according to an embodiment of the present invention. As shown in FIG. 2, in a four-pole earphone device 100 including a left side speaker terminal L, a right side speaker terminal R, a microphone terminal M and a ground terminal G, the four-pole earphone device 100 according to an embodiment of the present invention includes a first switch 111 arranged between the left side speaker terminal L and the right side speaker terminal R to switch connection of the left side speaker terminal L and the right side speaker terminal R, and a second switch 121 arranged between the right side speaker terminal R and the control unit 170 to switch connection of the right side speaker terminal R and the control unit 170. In addition, the four-pole earphone device 100 includes a third switch 141 arranged between the right side speaker terminal R and a microphone/key function unit 160 to switch connection of the right side speaker terminal R and the microphone/key function unit 160, the control unit 170 for monitoring power received from the terminal equipment, controlling switching of the first switch 111, the second switch 121 and the third switch 141 according to a value of the received power, and controlling the left side speaker terminal L, the right side speaker terminal R, the microphone/key function unit 160 and the earphone output units 112 and 122, and the microphone/key function unit 160 connected to the microphone terminal M and the control unit 170 to perform a microphone function and a key function of the four-pole earphone device 100.

The switch elements 111, 121 and 141 are arranged between the electrodes 110, 120, 130 and 140 respectively connected to the terminals L, R, G and M and the control unit 170 and controlled by the control unit 170. The control unit 170 connects the left side speaker terminal L and the control unit 170 by turning off the first switch 111 and turning on the second switch 121 and cuts off connection of the right side speaker terminal R and the microphone terminal M by turning off the third switch 141. The four-pole earphone device 100 of the present invention is basically in a state of turning off the first switch 111, turning on the second switch 121 and turning off the third switch 141. When the four-pole earphone device 100 in such a state receives an audio signal from the terminal equipment 200, a left side speaker output unit 112 and a right side speaker output unit 122 receive the audio signal from the left side speaker terminal L and the right side speaker terminal R and output the received audio signal.

When the four-pole earphone device 100 is supplied with power from the terminal equipment 200, the microphone terminal M is supplied with the power from the terminal equipment 200. When the power is supplied from the terminal equipment 200 through the microphone terminal M, the microphone terminal M is connected to a power supply unit (not shown) of the terminal equipment 200 and supplied with the power from the terminal equipment 200. When the power is supplied through the microphone terminal M, the microphone terminal M cannot transmit or receive a signal for a microphone/key function, and thus any other terminal L or R is arranged to transmit or receive a signal for the microphone/key function.

The control unit 170 monitors the power supplied through the microphone terminal M. When magnitude of the voltage monitored by the control unit 170 is smaller than a set value, the control unit 170 turns off the second switch 121, turns on the first switch 111 and turns on the third switch 141. The control unit 170 cuts off the audio signal received by the right side speaker terminal R from the terminal equipment 200 by turning off the second switch 121 and turning on the first switch 111. The control unit 170 connects the microphone/key function unit 160 and the right side speaker terminal R by turning on the third switch 141.

At this point, the audio signal is received by the left side speaker terminal L, and the microphone/key function unit 160 which controls a microphone MIC function and a key KEY function is connected to the right side speaker terminal R so that the microphone terminal M may perform only a function of receiving power, and the microphone MIC and key KEY functions are performed through connection to the right side speaker terminal R.

For example, if the voltage supplied through the microphone terminal M is 2.65V or higher, the control unit 170 maintains the OFF state of the first switch 111, the ON state of the second switch 121 and the OFF state of the third switch 141. If the voltage supplied through the microphone terminal M is 2.65V or lower, the control unit 170 changes the second switch 121 to OFF, the first switch 111 to ON and the third switch 141 to ON. At this point, a reference value of the voltage monitored by the control unit 170 to change the states of the switches 111, 121 and 141 is a previously set and can be changed.

Basically, the microphone terminal NI is connected to the microphone/key function unit 160 of the control module 150 and performs the microphone MIC and key KEY functions. If a key input signal is received by the microphone/key function unit 160 of the control module 150, the microphone/key function unit 160 transmits a key input command signal to the control unit 170. The control unit 170 transmits a signal corresponding to the key input command signal to the microphone terminal M through an FET so that the terminal equipment 200 may recognize that a key is pressed. In such a manner, the terminal equipment 200 connected to the microphone terminal M may receive a signal corresponding to a key input command signal. When voltage is supplied through the microphone terminal M, the first switch 111 is in an OFF state, the second switch 121 is in an ON state, and the third switch 141 is in an OFF state.

If the key input signal is received by the microphone/key function unit 160 or a call request signal is transmitted from the terminal equipment 200 while voltage is supplied, magnitude of the voltage is lowered. The control unit 170 continuously monitors the magnitude of the voltage and switches the switches 111, 121 and 141 if the magnitude of the voltage is smaller than a set value.

When the call request signal is received by the microphone/key function unit 160 while the voltage is supplied through the microphone terminal M, magnitude of the voltage monitored by the control unit 170 will be smaller than a set value. For example, if it is assumed that magnitude of the voltage supplied through the microphone terminal M is approximately 2.9V, magnitude of the monitored voltage will be approximately 2.5V when the call request signal is received from the terminal equipment 200. If the magnitude of the voltage is lower than a set value (e.g., 2.65V), the control unit 170 cuts off the audio signal received by the right side speaker terminal R from the terminal equipment 200 by changing the first switch 111 to ON, the second switch 121 to OFF and the third switch 141 to ON and connects the microphone/key function unit 160 to the right side speaker terminal R.

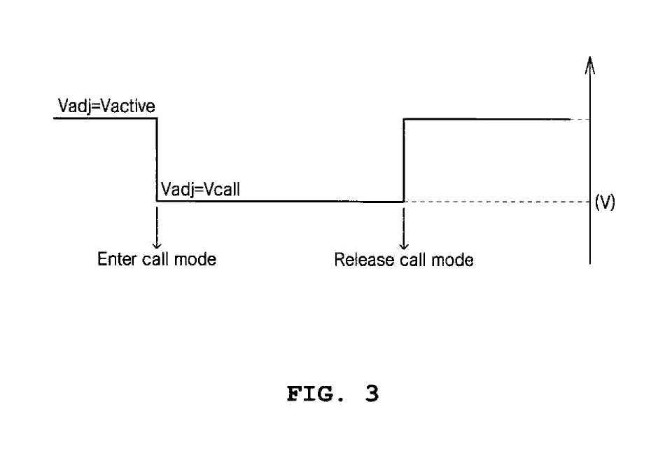

FIG. 3 is a graph showing voltage monitored by a control unit according to an embodiment of the present invention. As shown in FIG. 3, it is assumed that a state of supplying voltage through the microphone terminal M is referred to as an Active mode, and if magnitude of the voltage is lower than a set value in the Active mode, the state enters a call mode, which is a communication mode. The magnitude of the voltage at this point is the magnitude in the Active mode, and if it is increased, the call mode is released.

The microphone/key function unit 160 transmits a call connection signal to the terminal equipment 200 through the right side speaker terminal R. Although the microphone terminal M basically performs the microphone MIC function, when the voltage is supplied through the microphone terminal M, the microphone/key function unit 160 is connected to the right side speaker terminal R to perform the microphone MIC function.

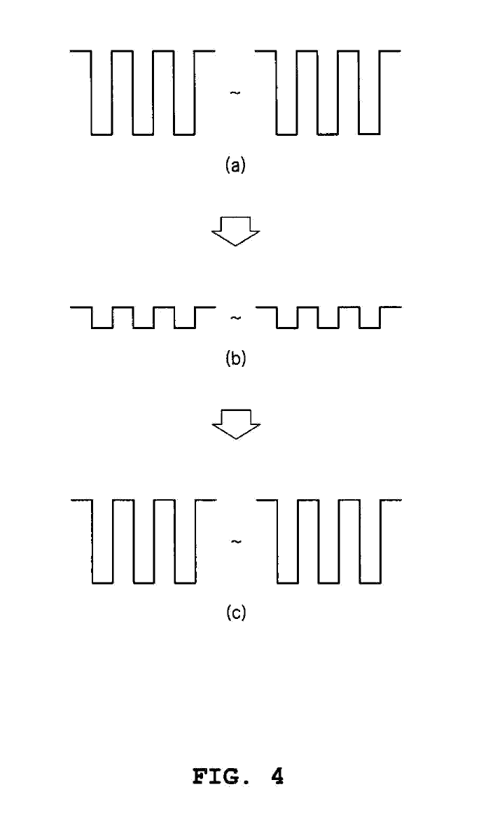

FIG. 4 is an exemplary view schematically showing a frequency transmission step according to an embodiment of the present invention. Referring to FIG. 4, if the microphone/key function unit 160 receives a key input signal, the control unit 170 transmits a frequency corresponding to the key input signal to the microphone terminal M. As shown in FIG. 4(a), if a key signal of a few tens to hundreds of KHZ is input through the microphone/key function unit 160, the microphone/key function unit 160 transmits a key input signal corresponding to the input key signal to the control unit 170. The control unit 170 transmits a frequency corresponding to such a key input signal to the terminal equipment 200 through the microphone terminal M. When the control unit 170 transmits a frequency corresponding to the key input signal to the microphone terminal M, it transmits the frequency as a frequency of a small signal as shown in FIG. 4(b). A detector 270 of the terminal equipment 200 restores, as shown in FIG. 4(c), the received small signal to an original signal like a frequency shown in FIG. 4(a), and the terminal equipment 200 may recognize the signal received from the four-pole earphone device 100.

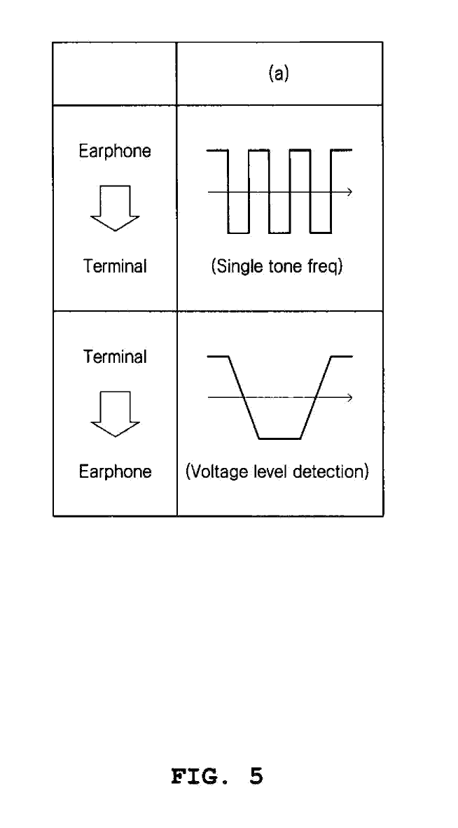

FIG. 5 is a graph schematically showing a communication mode according to an embodiment of the present invention. Referring to FIG. 5, when the four-pole earphone device 100 transmits a frequency to the terminal equipment 200 in a communication mode (FIG. 5(a)) according to an embodiment of the present invention, it transmit a single tone frequency as the frequency. The single tone frequency is transmitted to the terminal equipment 200 to inform that a key input signal is received by the microphone/key function unit 160 of the four-pole earphone device 100. Generally, if it is desired to inform the terminal equipment of each key input value, a multi-tone frequency is needed to distinguish each key signal. Although the four-pole earphone device 100 according to an embodiment of the present invention may transmit the multi-tone frequency to make the terminal equipment 200 recognize that a key has been input, it may make the terminal equipment 200 recognize the key input by transmitting a single tone frequency. Since the four-pole earphone device 100 according to an embodiment of the present invention makes the terminal equipment 200 recognize the key input and the right side speaker terminal R is connected to the microphone/key function unit 160 and recognizes the key input, it is sufficient to transmit the single tone frequency. In addition, although the active mode and the call mode may be distinguished by transmitting a multi-tone frequency from the terminal equipment 200 to the four-pole earphone device 100, as shown in FIG. 5(a), the active mode and the call mode may be recognized by transmitting voltage of a different magnitude according to the active mode and the call mode.

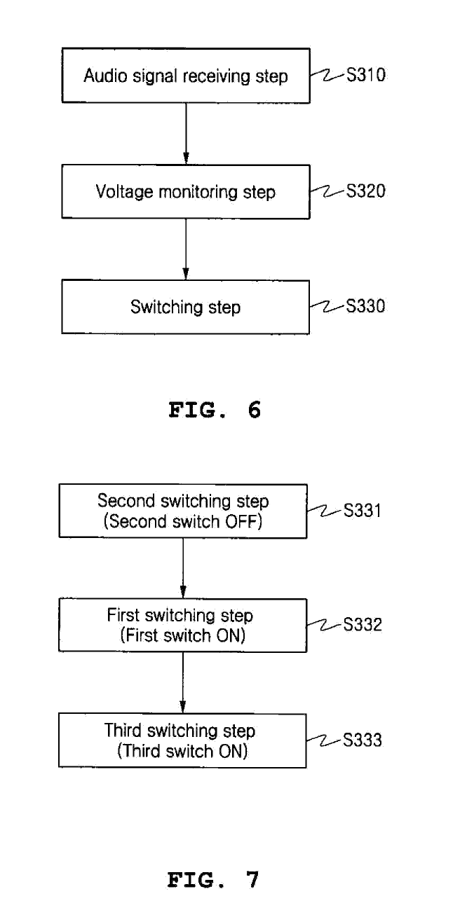

FIG. 6 is a flowchart schematically showing a method of controlling a four-pole earphone device according to an embodiment of the present invention. As shown in FIG. 6, in a method of controlling a four-pole earphone device 100 including a left side speaker terminal L, a right side speaker terminal R, a microphone terminal M and a ground terminal G, the method includes an audio signal receiving step S310 of receiving an audio signal from a terminal equipment 200, by the left side speaker terminal L and the right side speaker terminal R, a voltage monitoring step S320 of monitoring voltage supplied from the microphone terminal M, by a control module 150 including a control unit 170 which controls the left side speaker terminal L, the right side speaker terminal R and the microphone terminal M, and a switching step S330 of switching switch elements 111, 121 and 141 arranged in the control module 150 according to a result of the monitoring at the voltage monitoring step S320, by the control unit 170.

FIG. 7 is a flowchart schematically showing a method of controlling switching of a four-pole earphone device according to an embodiment of the present invention. As shown in FIG. 7, the switching step S330 includes a second switch switching step S331 of cutting off, when a value of the voltage monitored at the voltage monitoring step S320 is smaller than a set value, connection of the right side speaker terminal R and the control unit 170 by turning off the second switch 121 arranged between the right side speaker terminal R and the control unit 170, by the control unit 170. In addition, the switching step S330 includes a first switch switching step S332 of connecting the left side speaker terminal L and the right side speaker terminal R by turning on the first switch 111 arranged between the left side speaker terminal L and the right side speaker terminal R, by the control unit 170, and a third switch switching step S333 of connecting the right side speaker terminal R and the microphone/key function unit 160 by turning on the third switch 141 arranged between the right side speaker terminal R and the microphone/key function unit 160 arranged at one side of the control module 150 to perform a microphone or key function of the four-pole earphone device 100, by the control unit 170.

The four-pole earphone device switching control method further includes a frequency transmission step S340 of transmitting, when a key input signal is input from the microphone/key function unit 160 performing a microphone or key function of the four-pole earphone device 100, a frequency corresponding to the key input signal to the microphone terminal M, by the control unit 170. At this point, the frequency is preferably a single tone frequency.

Since the detailed description of the four-pole earphone device control method according to an embodiment of the present invention is different from the four-pole earphone device described above with reference to FIGS. 1 to 4 only in category and includes the same information, it will be omitted.

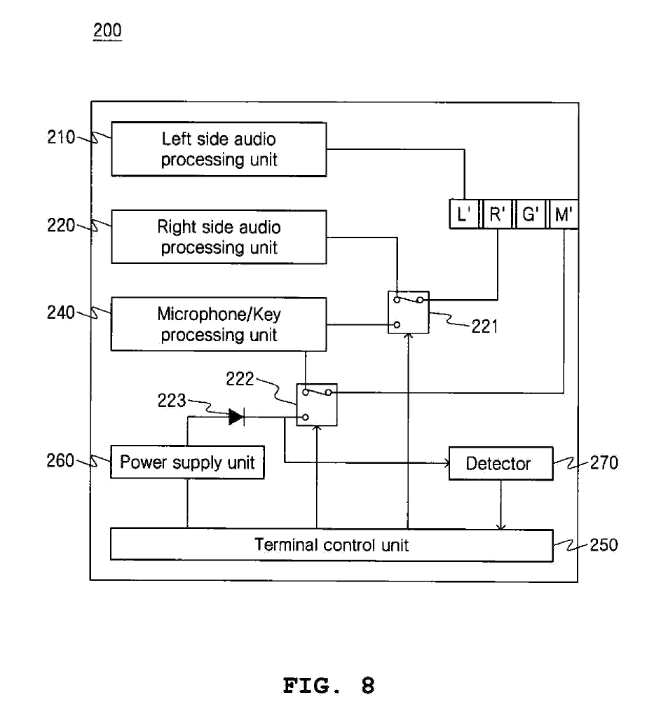

FIG. 8 is a view showing a terminal equipment supporting a four-pole earphone device according to an embodiment of the invention. As shown in FIG. 8, a terminal equipment supporting a four-pole earphone device according to an embodiment of the invention includes a left side audio terminal L′ for transmitting an audio signal to the left side speaker terminal L of the four-pole earphone device 100, a right side audio terminal R′ for transmitting an audio signal to the right side speaker terminal R of the four-pole earphone device 100, a microphone reception terminal M′ for receiving an audio signal or a key connection signal from the microphone terminal M of the four-pole earphone device 100, a common ground terminal G′ which becomes a common ground terminal when it contacts with the ground terminal G of the four-pole earphone device 100, a terminal control unit 250 for controlling the left side audio terminal L′, the right side audio terminal R′, the microphone reception terminal M′, the common ground terminal G′ and a power supply unit 260, and the power supply unit 260 for supplying power to the four-pole earphone device 100 through the microphone reception terminal M′.

At this point, the terminal equipment 200 supporting a four-pole earphone device further includes a left side audio processing unit 210 connected to the left side audio terminal L′ to process a left side audio signal, a right side audio processing unit 220 connected to the right side audio terminal R′ to process a right side audio signal, and a microphone/key processing unit 240 connected to the microphone reception terminal M′ to process a microphone signal and a key connection signal, and the right side audio processing unit 220 and the microphone/key processing unit 240 are connected to a first terminal switch 221, and the right side audio terminal R′ is connected to either the right side audio processing unit 220 or the microphone/key processing unit 240 according to switching of the first terminal switch 221.

If the four-pole earphone device 100 according to an embodiment of the present invention contacts with the terminal equipment 200, the left side audio terminal L′ and the left side speaker terminal L, the right side audio terminal R′ and the right side speaker terminal R, the common ground terminal G′ and the ground terminal G, and the microphone reception terminal M′ and the microphone terminal M are connected to each other. In an audio processing system in which the four-pole earphone device 100 contacts with the terminal equipment 200, basically, if an audio signal is transmitted from the left side audio processing unit 210 of the terminal equipment 200, the audio signal is transmitted, at this point, to the left side speaker terminal L of the four-pole earphone device 100 through the left side audio terminal L′, and the four-pole earphone device 100 receives the audio signal. If an audio signal is transmitted from the right side audio processing unit 220, the audio signal is transmitted, at this point, to the right side speaker terminal R of the four-pole earphone device 100 through the right side audio terminal R′, and the four-pole earphone device 100 receives the audio signal. If a microphone connection signal or a key input signal is transmitted from the microphone terminal M of the four-pole earphone device 100, the microphone connection signal or the key input signal is received through the microphone reception terminal M′ of the terminal equipment 200, and the microphone/key processing unit 240 of the terminal equipment 200 receives the microphone connection signal or the key input signal and performs a microphone function or a key function.

When voltage is supplied to the four-pole audio device 100 through the microphone reception terminal M′ of the terminal equipment 200 and the microphone terminal M connected to the microphone reception terminal M′, the microphone/key function unit 160 of the four-pole audio device 100 is connected to the right side speaker terminal R of the four-pole audio device 100, and the right side speaker terminal R transmits a signal transmitted from the microphone/key function unit 160 to the terminal equipment 200. At this point, since the voltage is supplied through the microphone reception terminal M′ of the terminal equipment 200, the microphone connection signal or the key connection signal transmitted from the four-pole audio device 100 will be received through the right side audio terminal R′ of the terminal equipment 200 connected to the right side speaker terminal R of the four-pole audio device 100. Only when the microphone connection signal or the key connection signal is received by the microphone/key processing unit 240, not by the right side audio processing unit 220, a microphone function or a key function corresponding to the microphone connection signal or the key connection signal can be performed.

To this end, the right side audio processing unit 220 and the microphone/key processing unit 240 are connected to the first terminal switch 221 so that the right side audio terminal R′ may be connected to either the right side audio processing unit 220 or the microphone/key processing unit 240 according to switching of the first terminal switch 221. When power lower than a set value is transmitted from the power supply unit 260 of the terminal equipment 200 to the microphone reception terminal M′, the terminal control unit 250 turns on the first terminal switch 221 so that the right side audio terminal R′ may be connected to the microphone/key processing unit 240.

Since the detailed description of the terminal equipment supporting the four-pole earphone device according to an embodiment of the present invention is different from the four-pole earphone device described above with reference to FIGS. 1 to 5 only in category and includes the same information, it will be omitted.

The present invention is effective in that an earphone device may receive power from a terminal equipment without including one more electrode.

In addition, the present invention is effective in that music listening, communication call and volume control can be simultaneously accomplished while receiving power from the terminal equipment, by implementing a simple circuit.

The embodiments disclosed in the present invention are provided not to limit the technical concept of the present invention but to illustrate the technical concept of the present invention. Therefore, the scope of the technical concept of the present invention is not limited by such embodiments. The scope of the protection of the present invention should be determined by reasonable interpretation of the appended claims and all technical concepts coming within the equivalency range of the present invention should be interpreted to be embraced in the scope of the right of the present invention.

What is claimed is:

1. A four-pole earphone device including a left side speaker terminal, a right side speaker terminal, a microphone terminal and a ground terminal, the device comprising:
a first switch arranged between the left side speaker terminal and the right side speaker terminal to switch connection of the left side speaker terminal and the right side speaker terminal;
a second switch arranged between the right side speaker terminal and a control unit to switch connection of the right side speaker terminal and the control unit;
a third switch arranged between the right side speaker terminal and a microphone/key function unit to switch connection of the right side speaker terminal and the microphone/key function unit;
the control unit for monitoring power received from a terminal equipment, controlling switching of the first switch, the second switch and the third switch according to a value of the received power, and controlling the left side speaker terminal, the right side speaker terminal, the microphone/key function unit and an earphone output unit; and
the microphone/key function unit connected to the microphone terminal and the control unit to perform a microphone function and a key function of the four-pole earphone device.

2. The device according to claim 1, wherein when the four-pole earphone device is supplied with power from the terminal equipment, the microphone terminal is supplied with the power from the terminal equipment.

3. The device according to claim 2, wherein when magnitude of the monitored power is smaller than a set value, the control unit allows the left side speaker terminal to receive the audio signal transmitted from the terminal equipment, blocks the right side speaker terminal not to receive the audio signal transmitted from the terminal equipment by turning on the first switch and turning off the second switch, and connects the microphone/key function unit and the right side speaker terminal by turning on the third switch.

4. The device according to claim 1, wherein if the microphone/key function unit receives a key input signal, the control unit transmits a frequency corresponding to the key input signal to the microphone terminal.

5. The device according to claim 4, wherein the frequency is a single tone frequency.

6. A method of controlling a four-pole earphone device including a left side speaker terminal, a right side speaker terminal, a microphone terminal and a ground terminal, the method comprising the steps of:
an audio signal receiving step of receiving an audio signal from a terminal equipment, by the left side speaker terminal and the right side speaker terminal;
a voltage monitoring step of monitoring voltage supplied from the microphone terminal, by a control module including a control unit which controls the left side speaker terminal, the right side speaker terminal and the microphone terminal; and
a switching step of switching switch elements arranged in the control module according to a result of the monitoring at the voltage monitoring step, by the control unit.

7. The method according to claim 6, wherein the switching step includes:
a second switch switching step of cutting off connection of the right side speaker terminal and the control unit by turning off the second switch arranged between the right side speaker terminal and the control unit, by the control unit;
a first switch switching step of connecting the left side speaker terminal and the right side speaker terminal by turning on the first switch arranged between the left side speaker terminal and the right side speaker terminal, by the control unit; and
a third switch switching step of connecting the right side speaker terminal and the microphone/key function unit by turning on the third switch arranged between the right side speaker terminal and the microphone/key function unit arranged at one side of the control module to perform a microphone or key function of the four-pole earphone device, by the control unit,
which are performed when a value of the voltage monitored at the voltage monitoring step is smaller than a set value.

8. The method according to claim 6, further comprising a frequency transmission step of transmitting, when a key input signal is input through the microphone/key function unit performing a microphone or key function of the four-pole earphone device, a frequency corresponding to the key input signal to the microphone terminal, by the control unit.

9. The method according to claim 8, wherein the frequency is a single tone frequency.

10. A terminal equipment supporting a four-pole earphone device, the terminal equipment comprising:
a left side audio terminal for transmitting an audio signal to a left side speaker terminal of the four-pole earphone device;
a right side audio terminal for transmitting an audio signal to a right side speaker terminal of the four-pole earphone device;
a microphone reception terminal for receiving an audio signal or a key connection signal from a microphone terminal of the four-pole earphone device;
a common ground terminal which becomes a common ground terminal when it contacts with a ground terminal of the four-pole earphone device;
a terminal control unit for controlling the left side audio terminal, the right side audio terminal, the microphone reception terminal, the common ground terminal and a power supply unit; and
the power supply unit for supplying power to the four-pole earphone device through the microphone reception terminal.

11. The terminal equipment according to claim 10, further comprising:
a left side audio processing unit connected to the left side audio terminal to process a left side audio signal;
a right side audio processing unit connected to the right side audio terminal to process a right side audio signal; and
a microphone/key processing unit connected to the microphone reception terminal to process a microphone signal and a key connection signal, wherein the right side audio processing unit and the microphone/key processing unit are connected to a first terminal switch, and the right side audio terminal is connected to either the right side audio processing unit or the microphone/key processing unit according to switching of the first terminal switch.
